(19) United States
(12) Patent Application Publication
(10) Pub. No.: US 2018/0067415 A1
(43) Pub. Date: Mar. 8, 2018

(54) TONER

(71) Applicant: KYOCERA Document Solutions Inc., Osaka (JP)

(72) Inventor: Masanori SUGAHARA, Osaka-shi (JP)

(73) Assignee: KYOCERA Document Solutions Inc., Osaka (JP)

(21) Appl. No.: 15/554,012

(22) PCT Filed: Mar. 10, 2016
(86) PCT No.: PCT/JP2016/057580

§ 371 Date: Aug. 28, 2017

(30) Foreign Application Priority Data
Mar. 19, 2015 (JP) 2015-056378

(51) Int. Cl. G03G 9/097; G03G 9/09; G03G 9/087; G03G 9/113

(52) U.S. Cl. CPC G03G 9/09725; G03G 9/09741; G03G 9/1132; G03G 9/08755; G03G 9/0924

(57) ABSTRACT

A toner includes a plurality of toner particles (10) each including a toner mother particle (11) and a plurality of external additive particles (12) attached to a surface of the toner mother particle (11). The external additive particles (12) each include a silica particles (12a), a metal hydroxide layer, and a coating layer (12b). The metal hydroxide layer is disposed on a surface of the silica particle (12a). At least a part of the coating layer (12b) is disposed on a surface of the metal hydroxide layer. The coating layer (12b) is made substantially from a nitrogen containing resin.

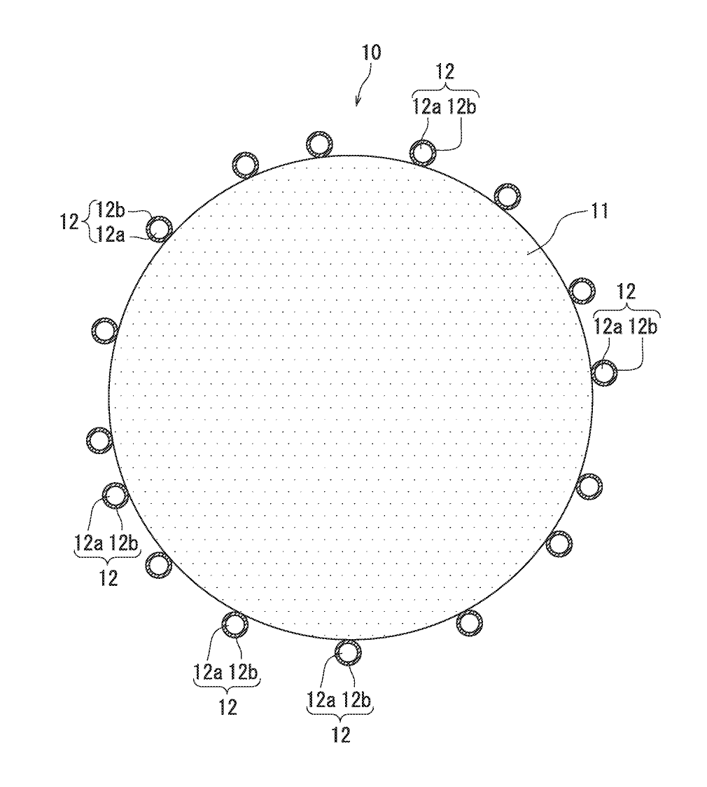

### TECHNICAL FIELD

The present invention relates to toners and particularly relates to a toner containing an external additive.

### BACKGROUND ART

A toner contains a plurality of toner particles. An external additive may be used for example in order to improve fluidity, chargeability, or cleaning ability of the toner. The toner particles included in the toner with the external additive each typically include a toner mother particle composed mainly of a binder resin and external additive particles attached to the surface of the toner mother particle. A suitable example of the external additive particles is silica particles each having a particle diameter ranging from several to several tens of nanometers.

For example, Patent Literature 1 discloses a technique by which surfaces of the silica particles are subjected to hydrophobization treatment with amino modified silicone oil.

### CITATION LIST

### Patent Literature

[Patent Literature 1] Japanese Patent Application Laid-Open Publication No. 10-39534

### SUMMARY OF INVENTION

### Technical Problem

However, an amino group is hydrophilic and therefore it is difficult to obtain a toner excellent in charge stability even by the technique disclosed in Patent Literature 1. In particular, the charge of the toner tends to reduce in a high-humidity environment.

The present invention has been made in view of the foregoing problem and has its object of providing a toner excellent in positive chargeability and charge stability. Another object of the present invention is to provide a toner excellent in durability.

### Solution to Problem

A toner according to the present invention includes a plurality of toner particles each including a toner mother particle and a plurality of external additive particles attached to a surface of the toner mother particle. The external additive particles each include a silica particle, a metal hydroxide layer, and a coating layer. The metal hydroxide layer is disposed on a surface of the silica particle. At least a part of the coating layer is disposed on a surface of the metal hydroxide layer. The coating layer is made substantially from a nitrogen containing resin.

### Advantageous Effects of Invention

According to the present invention, a toner excellent in positive chargeability and charge stability can be provided. Furthermore, according to the present invention, it may be possible that a toner excellent in durability in addition to or in place of the above advantage can be provided.

### BRIEF DESCRIPTION OF DRAWINGS

[Figure]

FIGURE shows one of toner particles included in a toner according to an embodiment of the present invention.

### DESCRIPTION OF EMBODIMENTS

The following describes an embodiment of the present invention in detail. Note that unless otherwise stated, evaluation results (for example, values indicating shapes or properties) for a powder (specific examples include toner mother particles, an external additive, and a toner) are number average values measured for an appropriate number of particles that are selected as average particles from the powder.

A number average particle diameter of a powder is a number average value of equivalent circular diameters of primary particles (diameters of circles having the same areas as projected areas of the respective particles) measured using a microscope unless otherwise stated.

The term chargeability refers to a chargeability in triboelectric charging unless otherwise stated. Intensity of positive chargeability (or negative chargeability) in triboelectric charging can be determined using for example a known triboelectric series.

In the present description, the term “-based” may be appended to the name of a chemical compound in order to form a generic name encompassing both the chemical compound itself and derivatives thereof. Also, when the term “-based” is appended to the name of a chemical compound used in the name of a polymer, the term indicates that a repeating unit of the polymer originates from the chemical compound or a derivative thereof. In the present description the term “(meth)acryl” is used as a generic term for both acryl and methacryl. Also, the term “(meth)acrylonitrile” is used as a generic term for both acrylonitrile (CH₂═CHCN) and methacrylonitrile (CH2═C(CH₃)CN).

The toner according to the present embodiment can be suitably used for example as a positively chargeable toner in development of an electrostatic latent image. The toner according to the present embodiment is a powder including a plurality of toner particles (particles each having a configuration described below). The toner may be used as a one-component developer. Alternatively, the toner may be mixed with a carrier using a mixer (for example, a ball mill) in order to prepare a two-component developer. A ferrite carrier is preferably used as a developer carrier in order that a high-quality image is formed. The amount of the toner in the two-component developer is preferably at least 5 parts by mass and no greater than 15 parts by mass relative to 100 parts by mass of the carrier in order to form a high-quality image, and more preferably at least 8 parts by mass and no greater than 12 parts by mass. A positively chargeable toner contained in the two-component developer is positively charged by friction with the carrier.

The configuration of toner particles 10 contained in the toner according to the present embodiment will be described blow with reference to FIGURE. As illustrated in FIGURE, a plurality of external additive particles 12 are used as an external additive in a toner particle 10. Specifically, the toner particle 10 includes a toner mother particle 11 and the plurality of external additive particles 12. The external additive particles 12 are attached to a surface of the toner mother particle 11. The external additive particles 12 each include a silica particle 12a and a coating layer 12b. The coating layer 12b is disposed on a surface of the silica particle 12a. The silica particle 12a is covered with the coating layer 12b. However, a metal hydroxide layer is disposed between the silica particle 12a and the coating layer 12b. Formation of metal hydroxide in a form of a film on the surface of the silica particle can result in formation of the metal hydroxide layer on the surface of the silica particle. The coating layer 12b is made substantially from a nitrogen containing resin.

Note that the toner particles included in the toner according to the present embodiment may each be a toner particle including no shell layer (also referred to below as a non-capsule toner particle) or a toner particle including a shell layer (also referred to below as a capsule toner particle). The capsule toner particle (encapsulated toner mother particle) includes for example a core having the same configuration as the toner mother particle 11 illustrated in FIGURE and a shell layer (capsule layer) on the surface of the core. For example, when a core that melts at low temperature is covered with a shell layer excellent in heat resistance, both high-temperature preservability and low-temperature fixability of the toner can be improved. The shell layer may be made substantially from a thermosetting resin (specifically, a melamine resin or the like) or a thermoplastic resin (specifically, an acrylic acid-based resin, a styrene-acrylic acid-based resin, or the like) or contain both the thermoplastic resin and the thermosetting resin. An additive may be dispersed in a resin forming the shell layer.

The toner according to the present embodiment can be used for image formation for example by an electrophotographic apparatus (image forming apparatus). The following explains an example of a method by which the electrophotographic apparatus forms an image.

First, an electrostatic latent image is formed on a photosensitive member (for example, a surface layer portion of a photosensitive drum) based on image data. Next, the formed electrostatic latent image is developed with a developer containing a toner. In a developing process, toner (for example, toner charged by friction between a carrier and a blade) on a development sleeve (for example, a surface layer portion of a development roller in a developing device) is attached to the electrostatic latent image on the photosensitive drum to form a toner image on the photosensitive member. The toner image on the photosensitive member is transferred onto an intermediate transfer target (for example, a transfer belt) in a subsequent transfer step, and the toner image on the intermediate transfer member is then transferred onto a recording medium (for example, paper). Next, the toner is fixed to the recording medium by heating the toner. Through the above processes, an image is formed on the recording medium. A full-color image can be formed by superposing for example toner images of four different colors: black, yellow, magenta, and cyan.

The toner according to the present embodiment has the following features (1) and (2).
(1) The toner particles included in the toner each include a toner mother particle and a plurality of external additive particles attached to the surface of the toner mother particle.
(2) The external additive particles each include a silica particle, a metal hydroxide layer disposed on a surface of the silica particle, and a coating layer at least a part of which is disposed on a surface of the metal hydroxide layer. The coating layer is made substantially from a nitrogen containing resin. The external additive particles defined in feature (2) refer below to external additive particles of the present embodiment. Further, a material for forming the coating layer is referred to as a coating material.

Feature (1) is advantages in improvement of fluidity, chargeability, or cleaning ability of the toner.

Feature (2) is advantages in improvement of positive chargeability, charge stability, and durability of the toner. Specifically, the silica particle is an acid substance and exhibits high negative chargeability. For the reason as above, the silica particle is hardly charged positively. Furthermore, the silica particle has high moisture adsorption property. For the reason as above, the charge of the silica particles tends to reduce in a high-humidity environment. However, in a configuration in which the external additive particles each include the metal hydroxide layer and the coating layer in addition to the silica particle, chargeability of the silica particle can be improved.

In the toner having feature (2), the metal hydroxide layer is disposed on the surface of the silica particle. The metal hydroxide layer has a tendency to be positively charged more highly than the silica particle. Further, the metal hydroxide layer tends to have a lower moisture adsorption property than the silica particles. For the reasons as above, it is thought that provision of the metal hydroxide layer on the surface of the silica particle can result in that the external additive particles are likely to be charged positively and that charge stability of the external additive particles is improved.

Moreover, in the toner having feature (2), at least a part of the coating layer made substantially from the nitrogen containing resin is disposed on the surface of the metal hydroxide layer. The nitrogen containing resin refers to a resin containing a nitrogen atom in its chemical structure. The nitrogen containing resin is likely to be positively charged. For the reason as above, it is thought that covering the silica particle with the coating layer results in that the external additive particles are likely to be positively charged. It is also thought that covering the silica particle with the coating layer can result in improvement of charge stability of the external additive particles. The nitrogen containing resin tends to have comparatively high hydrophobicity. For the reason as above, it is thought that covering the silica particle with the coating layer can result in that chargeability of the toner hardly degrades even in a high-humidity (for example, 80% RH) environment when compared to that in a normal-humidity environment and chargeability at a substantially equal level to that in the normal-humidity environment can be maintained. Use of the external additive particles as described above can hardly involve variation in charge of the toner even in a situation in which the toner is stored for an extended period of term in either a normal-temperature and normal-humidity environment or a high-temperature and high-humidity environment (see Tables 2 and 3, which will be described later). It is also though that in a configuration in which the silica particle is covered with the coating layer, durability of the external additive particles (eventually, durability of the toner) can be improved.

The coating layer contains the nitrogen containing resin preferably at a ratio of at least 80% by mass in order to improve positive chargeability, charge stability, and durability of the toner, more preferably at least 90% by mass, and further preferably 100% by mass.

An area ratio of a region of a surface region of the silica particle that is covered with the coating layer (also referred to below as a coat ratio) is preferably at least 50% in order to improve positive chargeability, charge stability, and durability of the toner, more preferably at least 80% and further preferably at least 90%. The coat ratio is expressed by “(coat ratio)=100×(area of surface region of silica particle covered with coating layer)/(area of entire surface region of silica particle)”. The metal hydroxide layer may cover the entirety of the silica particle or partially cover the silica particle. In a configuration in which the metal hydroxide layer partially covers the silica particle, the coat ratio of the external additive particle can be increased by the coating layer having a first portion located on the surface of the silica particle and a second portion located on the surface of the metal hydroxide layer. While, the coat ratio of the external additive particle is preferably no greater than 95% in order to improve production ease of the external additive particles.

In a configuration in which an intermediate of the nitrogen containing resin has a methylol group, the intermediate in the methylol group tends to form a bond with a metal hydroxide having a hydroxyl group in a polymerization reaction for synthesis of the nitrogen containing resin. For example, heating under an acidic catalyst causes a dehydration condensation reaction between the metal hydroxide and the methylol group, with a result that a covalent bond is likely to be formed therebetween. It is preferable to form a bond originating from the methylol group between the metal hydroxide layer and the coating layer in order to firmly bond the coating layer to the metal hydroxide layer. Further, a silanol group is thought to be present in a region of the surface of the silica particle that is not covered with the metal hydroxide. Such the silanol group is likely to form a covalent bond with the methylol group in the intermediate. Formation of the covalent bond as above can achieve firm boding between the silica particle and the coating layer. A bond originating from the silanol group is preferably formed between the silica particle and the coating layer (specifically the aforementioned first portion) in order to firmly bond the coating layer to the silica particle.

The coating layer preferably contains a thermosetting resin as the nitrogen containing resin in order to improve durability of the toner. It is thought that heating promotes a curing reaction of the thermosetting resin, thereby increasing strength of the thermosetting resin. The thermosetting resin tends to have high strength. For the reason as above, when the coating layer of the external additive particle contains the thermosetting resin, stress resistance of the toner can be increased. It is preferable that the coating layer further contains a thermoplastic resin (specific example is a urethane resin) as the nitrogen containing resin in addition to the thermosetting resin (specific examples include a melamine resin and a urea resin) in order to improve film quality of the coating layer.

The coating layers are preferably formed in an aqueous medium (acidic or alkaline aqueous solution) in order that the silica particle is covered with the coating layer having uniform thickness. The coating material (particularly, a monomer for synthesis of the nitrogen containing resin) is preferably water soluble in order to form the coating layers in the aqueous medium. Note that the aqueous medium is a medium of which main component is water (specific examples include pure water and a mixed liquid of water and a polar medium). The aqueous medium may function as a solvent. A solute may be dissolved in the aqueous medium. The aqueous medium may function as a dispersoid. A dispersoid may be dispersed in the aqueous medium. Examples of the polar medium in the aqueous medium that can be used include alcohols (specific examples include methanol and ethanol).

The metal hydroxide layers are preferably formed in an aqueous medium (acidic or alkaline aqueous solution) in order that the silica particle is covered with the metal hydroxide layer having uniform thickness. Furthermore, the metal hydroxide layer preferably contains at least one of an aluminum hydroxide and a magnesium hydroxide in order to form the metal hydroxide layers in the aqueous medium. Aluminum hydroxide and magnesium hydroxide each are hardly soluble or insoluble in water that is neutral and soluble in an acidic or alkaline aqueous solution. For the reason as above, in a configuration in which the metal hydroxide forming the metal hydroxide layer is an aluminum hydroxide or a magnesium hydroxide, pH control of an aqueous medium containing the aluminum hydroxide or the magnesium hydroxide can facilitate adjustment of film quality or film thickness of the metal hydroxide layer to be formed.

An external additive particles (other external additive particles) other than the external additive particles of the present embodiment may be attached to the surface of the toner mother particle in addition to the external additive particles of the present embodiment. For example, when the other external additive particles (specifically, titanium oxide particles or the like) are attached to the surface of the toner mother particle in addition to the external additive particles of the present embodiment, the charge and the like of the toner can be easily adjusted.

The toner according to the present embodiment includes a plurality of toner particles having both features (1) and (2) (also referred to below as toner particles of the present embodiment). The toner including the toner particles of the present embodiment is excellent in positive chargeability, charge stability, and durability (see Tables 2 and 3, which will be described later). Note that the toner preferably includes the toner particles of the present embodiment at a ratio of at least 80% by number in order to improve positive chargeability, charge stability, and durability of the toner, more preferably at least 90% by number, and further preferably 100% by number.

The following describes the toner mother particle (i.e., the binder resin and the internal additives) and the external additive in order.

[Toner Mother Particle]

The toner mother particle contains a binder resin. Further, the toner mother particle may optionally contain an internal additive (for example, a colorant, a releasing agent, or a charge control agent). Non-essential components (for example, the colorant, the releasing agent, or the charge control agent) may be omitted according to the intended use of the toner. The toner mother particles may additionally contain a magnetic powder as necessary.

The toner mother particle preferably has a particle diameter of at least 4 μm and no greater than 10 μm in order that a high-quality image is formed with the toner.

(Binder Resin)

Typically, the binder resin constitutes a large proportion (for example, no less than 85% by mass) of components of the toner mother particles. Properties of the binder resin are therefore expected to have great influence on an overall property of the toner mother particles. The binder resin preferably has a solubility parameter (SP value) of at least 10 in order to improve wettability of the toner mother particles to an aqueous medium, and more preferably at least 18 and no greater than 28.

The binder resin preferably has a glass transition point (Tg) of at least 45° C. and no greater than 65° C. in order to improve preservability, a shape retention characteristic, or durability of the toner, and more preferably at least 50° C. and no greater than 60° C. When a heat absorption curve (vertical axis: heat flow (DSC signal), horizontal axis: temperature) of a sample (binder resin) is plotted using a differential scanning calorimeter, Tg of the sample can be obtained from a point of variation of specific heat on the plotted heat absorption curve. For example, 10 mg of a sample (binder resin) is placed on an aluminum pan, and the heat absorption curve of the sample is plotted with use of an empty aluminum pan as a reference under conditions of a measurement temperature range of 25° C. to 200° C. and a heating rate of 10° C./min.

To improve fixability of the toner, a thermoplastic resin is preferable as the binder resin. Examples of a thermoplastic resin in a configuration in which the binder resin includes the thermoplastic resin include styrene-based resin, acrylic acid-based resins (specific examples include a polymer of acrylic acid ester and a polymer of methacrylic acid ester), olefin-based resins (specific examples include a polyethylene resin and a polypropylene resin), vinyl chloride resin, polyvinyl alcohol, vinyl ether resin, N-vinyl resin, polyester resin, polyamide resin, and urethane resin. In addition, copolymers of the resins listed above, that is, copolymers including any repeating unit introduced into the resins listed above (specific examples include styrene-acrylic acid-based resins and styrene-butadiene-based resins) are preferable. A styrene-acrylic acid-based resin or a polyester resin is particularly preferable in order to improve dispersibility of a colorant in the toner, chargeability of the toner, and fixability of the toner to a recording medium.

The following describes a styrene-acrylic acid-based resin that can be used as the binder resin. The styrene-acrylic acid-based resin is a copolymer of at least one styrene-based monomer and at least one acrylic acid-based monomer.

Examples of a styrene-based monomer that can be preferably used for preparing the styrene-acrylic acid-based resin include styrene, α-methylstyrene, p-hydroxystyrene, m-hydroxystyrene, vinyltoluene, α-chlorostyrene, o-chlorostyrene, m-chlorostyrene, p-chlorostyrene, and p-ethylstyrene.

Examples of an acrylic acid-based monomer that can be preferably used for preparing the styrene-acrylic acid-based resin include (meth)acrylic acid, (meth)acrylonitrile, (meth)acrylic acid alkyl ester, and (meth)acrylic acid hydroxyalkyl ester. Preferable examples of the (meth)acrylic acid alkyl ester include methyl (meth)acrylate, ethyl (meth)acrylate, n-propyl (meth)acrylate, iso-propyl (meth)acrylate, n-butyl (meth)acrylate, iso-butyl (meth)acrylate, and 2-ethylhexyl (meth)acrylate. Preferable examples of the (meth)acrylic acid hydroxyalkyl ester include 2-hydroxyethyl (meth)acrylate, 3-hydroxypropyl (meth)acrylate, 2-hydroxy propyl (meth)acrylate, and 4-hydroxybutyl (meth)acrylate.

When a monomer having a hydroxyl group (specific examples include p-hydroxystyrene, m-hydroxystyrene, and (meth)acrylic acid hydroxyalkyl ester) is used in preparing the styrene-acrylic acid-based resin, the hydroxyl group can be introduced into the styrene-acrylic acid-based resin. Further, adjustment of the amount of the monomer having the hydroxyl group can result in adjustment of the hydroxyl value of the styrene-acrylic acid-based resin to be yielded.

When an acrylic acid-based monomer having a carboxyl group is used in preparing the styrene-acrylic acid-based resin, the carboxyl group can be introduced into the styrene-acrylic acid-based resin. Further, adjustment of the amount of (meth)acrylic acid can result in adjustment of the acid value of the styrene-acrylic acid-based resin to be yielded.

In a situation in which a styrene-acrylic acid-based resin is used as a binder resin of toner mother particles, the styrene-acrylic acid-based resin preferably has a number average molecular weight (Mn) of at least 2,000 and no greater than 3,000 in order to improve strength of the toner mother particles and fixability of the toner. The styrene-acrylic acid-based resin preferably has a molecular weight distribution (ratio Mw/Mn of mass average molecular weight (Mw) relative to number average molecular weight (Mn)) is preferably at least 10 and no greater than 20. Gel permeation chromatography is employable for measuring Mn and Mw of the styrene-acrylic acid-based resin.

The following describes a polyester resin that can be used as the binder resin. The polyester resin can be obtained by condensation polymerization of at least one alcohol and at least one carboxylic acid.

A dihydric alcohol such as a diol or a bisphenol can be used for preparing the polyester resin.

Examples of a diol that can be preferably used for preparing the polyester resin include ethylene glycol, diethylene glycol, triethylene glycol, 1,2-propanediol, 1,3-propanediol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol.

Examples of a bisphenol that can be preferably used for preparing the polyester resin include bisphenol A, hydrogenated bisphenol A, bisphenol A ethylene oxide adduct, and bisphenol A propylene oxide adduct.

For preparing the polyester resin, a tri- or higher hydric alcohol can be preferably used, such as sorbitol, 1,2,3,6-hexanetetraol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, or 1,3,5-trihydroxymethylbenzene.

For preparing the polyester resin, a dibasic carboxylic acid can be preferably used, such as maleic acid, fumaric acid, citraconic acid, itaconic acid, glutaconic acid, phthalic acid, isophthalic acid, terephthalic acid, cyclohexanedicarboxylic acid, adipic acid, sebacic acid, azelaic acid, malonic acid, succinic acid, alkyl succinic acid (specific examples include n-butylsuccinic acid, isobutylsuccinic acid, n-octylsuccinic acid, n-dodecylsuccinic acid, and isododecylsuccinic acid), or alkenyl succinic acid (specific examples include n-butenylsuccinic acid, isobutenylsuccinic acid, n-octenylsuccinic acid, n-dodecenylsuccinic acid, and isododecenylsuccinic acid).

For preparing the polyester resin, a tri- or higher-basic carboxylic acid can be preferably used, such as 1,2,4-benzenetricarboxylic acid (trimellitic acid), 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, and EMPOL trimer acid.

The di- or tri- or higher-basic carboxylic acids listed above may be deformed into an ester-forming derivative (specific examples include acid halide, acid anhydride, and lower alkyl ester) for use. The term “lower alkyl” herein refers to an alkyl group having a carbon number of at least 1 and no greater than 6.

When the respective amounts of the alcohol and the carboxylic acid are changed in preparation of the polyester resin, the acid value and the hydroxyl value of the polyester resin can be adjusted. The acid value and the hydroxyl value of the polyester resin tend to reduce as the molecular weight of the polyester resin is increased.

In a situation in which a polyester resin is used as the binder resin of the toner mother particles, the polyester resin preferably has a number average molecular weight

(Mn) of at least 1,000 and no greater than 2,000 in order to improve strength of the toner mother particles and fixability of the toner. The polyester resin preferably has a molecular weight distribution (ratio Mw/Mn of mass average molecular weight (Mw) relative to number average molecular weight (Mn)) of at least 9 and no greater than 21. Gel permeation chromatography is employable for measuring Mn and Mw of the polyester resin.

The binder resin may include a thermoplastic resin alone or two or more resins (for example, a thermoplastic resin and a thermosetting resin) in combination. A cross-linking agent may be added to the binder resin. Formation of a cross-linking structure in the binder resin can achieve improvement of preservability, a shape retention characteristic, or durability of the toner. Examples of a thermosetting resin that can be used as the binder resin include bisphenol A epoxy resin, hydrogenated bisphenol A epoxy resin, novolac epoxy resin, polyalkylene ether epoxy resin, cycloaliphatic epoxy resin, and cyanate-based resin. One of the thermosetting resins listed above may be used alone, or two or more of the thermosetting resins listed above may be used in combination.

(Colorant)

The toner mother particle may optionally contain a colorant. The colorant can be a commonly known pigment or dye that matches the color of the toner. The amount of the colorant is preferably at least 1 part by mass and no greater than 20 parts by mass relative to 100 parts by mass of the binder resin in order that a high-quality image is formed with the toner, and more preferably at least 2 parts by mass and no greater than 10 parts by mass.

The toner mother particle may contain a black colorant. The black colorant is for example carbon black. The black colorant may be a colorant that is adjusted to a black color using a yellow colorant, a magenta colorant, and a cyan colorant.

The toner mother particle may optionally contain a non-black colorant such as a yellow colorant, a magenta colorant, or a cyan colorant.

At least one compound selected from the group consisting of condensed azo compounds, isoindolinone compounds, anthraquinone compounds, azo metal complexes, methine compounds, and arylamide compounds can be used as the yellow colorant. Examples of a yellow colorant that can be preferably used include C.I. Pigment Yellow (3, 12, 13, 14, 15, 17, 62, 74, 83, 93, 94, 95, 97, 109, 110, 111, 120, 127, 128, 129, 147, 151, 154, 155, 168, 174, 175, 176, 180, 181, 191, and 194), naphthol yellow S, Hansa Yellow G, and C.I. Vat Yellow that each are classified according to a color index.

At least on compound selected from the group consisting of condensed azo compounds, diketopyrrolopyrrole compounds, anthraquinone compounds, quinacridone compounds, basic dye lake compounds, naphthol compounds, benzimidazolone compounds, thioindigo compounds, and perylene compounds can be used as the magenta colorant. Examples of a magenta colorant that can be preferably used include C.I. Pigment Reds (2, 3, 5, 6, 7, 19, 23, 48:2, 48:3, 48:4, 57:1, 81:1, 122, 144, 146, 150, 166, 169, 177, 184, 185, 202, 206, 220, 221, and 254) that each are classified according to a color index.

At least one compound selected from the group consisting of copper phthalocyanine compounds, anthraquinone compounds, and basic dye lake compounds can be used as the cyan colorant. Examples of a cyan colorant that can be preferably used include C.I. Pigment Blue (1, 7, 15, 15:1, 15:2, 15:3, 15:4, 60, 62, and 66), Phthalocyanine Blue, C.I. Vat Blue, and C.I. Acid Blue that each are classified according to a color index.

(Releasing Agent)

The toner mother particle may optionally contain a releasing agent. The releasing agent is for example used to improve fixability or offset resistance of the toner. The amount of the releasing agent is preferably at least 1 part by mass and no greater than 30 parts by mass relative to 100 parts by mass of the binder resin in order to improve fixability or offset resistance of the toner, and more preferably at least 3 parts by mass and no greater than 20 parts by mass.

Examples of a releasing agent that can be preferably used include: aliphatic hydrocarbon waxes such as low molecular weight polyethylene, low molecular weight polypropylene, polyolefin copolymer, polyolefin wax, microcrystalline wax, paraffin wax, and Fischer-Tropsch wax; oxides of aliphatic hydrocarbon waxes such as polyethylene oxide wax and block copolymer of polyethylene oxide wax; plant waxes such as candelilla wax, carnauba wax, Japan wax, jojoba wax, and rice wax; animal waxes such as beeswax, lanolin, and spermaceti; mineral waxes such as ozokerite, ceresin, and petrolatum; waxes having a fatty acid ester as a main component such as montanic acid ester wax and castor wax; and waxes in which a fatty acid ester has been partially or fully deoxidized such as deoxidized carnauba wax. One of the releasing agents listed above may be used alone, or two or more of the releasing agents listed above may be used in combination.

A compatibilizer may be added to the toner mother particle in order to improve compatibility between the binder resin and the releasing agent.

(Charge Control Agent)

The toner mother particle may optionally contain a charge control agent. The charge control agent is for example used to improve chargeability or a charge rise characteristic of the toner. The charge rise characteristic of the toner is an indicator as to whether the toner can be charged to a specific charge level in a short period of time.

Cationic strength of the toner can be increased by including a positively chargeable charge control agent in the toner mother particle. Anionic strength of the toner can be increased by including a negatively chargeable charge control agent in the toner mother particle.

Examples of a positively chargeable charge control agent that can be preferably used include: azine compounds such as pyridazine, pyrimidine, pyrazine, 1,2-oxazine, 1,3-oxazine, 1,4-oxazine, 1,2-thiazine, 1,3-thiazine, 1,4-thiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes such as Azine Fast Red FC, Azine Fast Red 12BK, Azine Violet BO, Azine Brown 3G, Azine Light Brown GR, Azine Dark Green BH/C, Azine Deep Black EW, and Azine Deep Black 3RL; acid dyes such as nigrosines (specific examples include nigrosine BK, nigrosine NB, and nigrosine Z); metal salts of a naphthenic acid or a higher organic carboxylic acid; alkoxylated amine; alkylamide; and quaternary ammonium salts such as benzyldecylhexylmethyl ammonium chloride and decyltrimethylammonium chloride. Use of either or both a nigrosine and a quaternary ammonium salt is particularly preferable among the positively chargeable charge control agents listed above in order to improve the charge rise characteristic.

An organic metal complex or a chelate compound can be preferably used as the negatively chargeable charge control agent. Examples of a negatively chargeable charge control agent that can be preferably used to improve the charge rise characteristic of the toner include metal acetylacetonate complexes (specific examples include aluminum acetylacetonate and iron(II) acetylacetonate), salicylic acid-based metal complexes (a specific example is 3,5-di-tert-butylsalicylic acid chromium), and salicylic acid-based metal salts, with a salicylic acid-based metal complex or a salicylic acid-based metal salt being particularly preferable.

One of the charge control agents listed above may be used alone, or two or more of the charge control agents listed above may be used in combination. The amount of the charge control agent is preferably at least 1.5 parts by mass and no greater than 15 parts by mass relative to 100 parts by mass of the toner in total, and more preferably at least 3 parts by mass and no greater than 8 parts by mass.

[External Additive]

The external additive is a powder including a plurality of external additive particles. For example, when the toner mother particles and the external additive are stirred together, the external additive particles are attached (physically bonded) to the surfaces of the toner mother particles by a physical power. The toner according to the present embodiment has the aforementioned features (1) and (2). The toner particles included in the toner according to the present embodiment each include a toner mother particle and a plurality of external additive particles attached to the surface of the toner mother particle.

The external additive particles of the present embodiment each include a silica particle, a metal hydroxide layer, and a coating layer. The coating layer is made substantially from a nitrogen containing resin. The metal hydroxide layer is disposed on the surface of the silica particle. At least a part of the coating layer is disposed on the surface of the metal hydroxide layer. The metal hydroxide layer on the surface of the silica particle forming the external additive particle preferably has higher positive chargeability than the silica particle in order to increase cationic strength of the toner particle. The metal hydroxide forming the metal hydroxide layer preferably is an aluminum hydroxide or a magnesium hydroxide in order to increase cationic strength of the toner particles. However, any metal hydroxide can be used for forming the metal hydroxide layer and a zinc hydroxide may be used for example. The surface of the coating layer may be subjected to hydrophobization treatment. When a hydroxyl group on the surface of the coating layer is removed for example using an amino modified silicone oil, charge stability of the toner is thought to be improved.

One type of external additive particles may be used alone, or two or more types of external additive particles may be used in combination. For example, two or more types of external additive particles of the present embodiment may be attached to the surfaces of the toner mother particles. Alternatively, another type of external additive particles may be attached to the surfaces of the toner mother particles in addition to the external additive particles of the present embodiment. Examples the other type of external additive particles that can be preferably used include particles of metal oxides (specific examples include alumina, titanium oxide, magnesium oxide, zinc oxide, strontium titanate, and barium titanate). The amount of the external additive (where plural types of external additive particles are used, the total amount of these types of external additive particles) is preferably at least 1 part by mass and no greater than 10 parts by mass relative to 100 parts by mass of the toner mother particles in order to improve fluidity or handleability of the toner, and more preferably at least 1.5 parts by mass and no greater than 5.0 parts by mass. The external additive preferably has a volume median diameter (D₅₀) of at least 10 nm and no greater than 100 nm in order to improve fluidity or handleability of the toner, and more preferably at least 15 nm and no greater than 50 nm.

In a case in which the toner is a positively chargeable toner, for example, the toner is thought to have a configuration in which: the toner mother particles are cationic (positively chargeable); the silica particles of the external additive are anionic (negatively chargeable); and the coating layers of the external additive are cationic (positively chargeable). Typically, silica has a silanol group. For the reason as above, the silica particles are likely to be negatively charged. However, when the cationic coating layer is disposed on the surface of the silica particle, it can be ensured that the toner is positively charged. Hydrophilic fumed silica particles can be preferably used as the silica particles of the external additive. The toner mother particle preferably contains two or more positively chargeable charge control agents in order to increase cationic strength of the toner mother particle. In a configuration in which the toner mother particle contains two or more positively chargeable charge control agents, the toner mother particle particularly preferably contains a nigrosine and a resin including a repeating unit derived from a quaternary ammonium salt as the positively chargeable charge control agents. When two or more positively chargeable charge control agents are contained in the toner mother particle, sufficiently high cationic strength can be imparted to the toner mother particle for example even in a configuration in which the binder resin of the toner mother particle is a polyester resin.

The coating layer may be made substantially from a thermoplastic resin only or a thermoplastic resin only, or contain both a thermosetting resin and a thermoplastic resin. The coating layer preferably contains a thermosetting resin in order to improve high-temperature preservability of the toner, and more preferably is made substantially from the thermosetting resin. In order to improve high-temperature preservability of the toner, at least 80% by mass of the thermosetting resin is preferably contained in the coating layer among resins in the coating layer, with at least 90% by mass being more preferable and 100% by mass being further preferable.

Examples of a preferable nitrogen containing resin that forms the coating layer include thermosetting resins (specific examples include a melamine resin, a urea resin, a guanamine resin, a polyimide resin, and an aniline resin) and thermoplastic resins (specific examples include a polyamide resin, a urethane resin, and a polyamide-imide resin). A thermosetting resin is preferably used as the nitrogen containing resin forming the coating layer in order to improve durability of the toner.

At least one monomer selected from the group consisting of methylol melamine, melamine, methylol ureas (for example, dimethylol dihydroxyethyleneurea), urea, benzoguanamine, acetoguanamine, and spiroguanamine can be preferably used for preparing the nitrogen containing resin (particularly, a thermosetting resin) for forming the coating layer.

A melamine resin and a urea resin, which each have a complicated three-dimensional mesh structure, have high hardness and high durability. Further, the melamine resin and the urea resin, which each are a thermosetting resin, have high heat resistance. Further, the melamine resin and the urea resin, which each are a nitrogen containing resin, are strong tendency of being positively charged. Polymerization of the melamine resin or the urea resin is carried out through dehydration condensation. Intermediates of the melamine resin and the urea resin each have a methylol group. As such, the melamine resin and the urea resin are each likely to bond to metal hydroxide. For example, heating under an acidic catalyst tends to cause dehydration condensation between the metal hydroxide and the methylol group to form a covalent bond therebetween. For the reason as above, when the melamine resin or the urea resin is used as the nitrogen containing resin contained in the coating layer, the coating layers that firmly bond to the metal hydroxide layers are likely to be formed.

A melamine resin can be obtained by condensation polymerization of melamine and formaldehyde. Specifically, an addition reaction between melamine and formaldehyde is caused. This yields a precursor (methylol melamine) of the melamine resin. Next, a condensation reaction (cross-linking reaction) between molecules of methylol melamine is caused. In the above reaction, an amino group of one molecule of the methylol melamine is bonded to an amino group of another molecule of the methylol melamine through a methylene group. As a result, a melamine resin is yielded.

Change in type of functional groups or the number of functional groups of the methylol melamine can result in change in solubility of the methylol melamine in water. Accordingly, polymerization of methylol melamine can be comparatively easily carried out in an aqueous medium.

A urea resin can be obtained by condensation polymerization of urea and formaldehyde. Specifically, the urea resin can be synthesized through use of urea in place of melamine in the above melamine resin synthesis method.

[Toner Production Method]

The toner having the aforementioned configuration according to the present embodiment can be produced for example in a manner that the toner mother particles and the external additive are mixed together using a mixer to attach the external additive to the surfaces of the toner mother particles. The following describes a process of preparing the toner mother particles and a process of preparing the external additive.

(Preparation of Toner Mother Particles)

The toner mother particles are preferably produced by an aggregation method or a pulverization method in order to easily prepare preferable toner mother particles. The pulverization method is more preferable to produce the toner mother particles.

An example of the pulverization method will be described below. The binder resin and an internal additive (for example, at least one of a colorant, a releasing agent, a charge control agent, and a magnetic powder) are mixed together first. Subsequently, the resultant mixture is melt-knead. The resultant melt-knead substance is then pulverized and classified. Through the above, toner mother particles having a desired particle size can be obtained.

An example of the aggregation method will be described below. First, fine particles of the binder resin, the releasing agent, and the colorant are caused to aggregate in an aqueous medium containing the aforementioned fine particles until particles having a desired diameter are obtained. Through the above aggregation, aggregated particles containing the binder resin, the releasing agent, and the colorant are formed. Subsequently, the resultant aggregated particles are heated to coalesce components contained in the agglomerated particles. As a result, a dispersion of toner mother particles are obtained. Unnecessary substances (for example, a dispersant) are removed from the dispersion of the toner mother particles to obtain the toner mother particles.

(Preparation of External Additive)

An example of an external additive production method will be described below. Silica particles are first prepared. Next, metal hydroxide layers are formed on the surfaces of the prepared silica particles. Subsequently, coating layers are formed on the surfaces of the metal hydroxide layers. The coating layers are made substantially from a nitrogen containing resin. The coating layer may be formed on the entirety or only a part of the metal hydroxide layer. The metal hydroxide layers and the coating layers may be each formed by a reaction method or a solution application method. In a situation in which the reaction method is employed for forming layers (metal hydroxide layers or coating layers) on the surfaces of particles, the layers are formed on the surfaces of the particles in a manner that the particles are dispersed in a solvent in which a material of the layers is dissolved to cause a reaction of the material in the solvent. In a situation in which the solution application method is employed for forming layers (metal hydroxide layers or coating layers) on the surfaces of particles, the layers are formed on the surfaces of the particles in a manner that a solution in which the material is dissolved is applied onto the surfaces of the particles and the solvent is then removed. In a configuration in which layers are formed by the reaction method, firm bondability between a layer and a particle tends to be maintained for an extended period of term.

The production method of the toner according to the present embodiment will be further described based on a more specific example. First, the silica particles are dispersed in an aqueous medium to obtain a silica particle dispersion. Any commercially available silica particles can be used for example as the silica particles. The silica particle dispersion is preferably stirred using a mixer (specific example is “HIVIS MIX (registered Japanese trademark) produced by PRIMIX Corporation) in order to highly disperse the silica particles in the liquid.

Subsequently, the temperature of the liquid is adjusted to a first temperature (for example, at least 40° C. and no greater than 90° C.) and the pH of the liquid is adjusted to a first pH (for example, at least 3 and no greater than 6 or at least 8 and no greater than 11). The first temperature and the first pH are determined such that when a solution of a metal hydroxide is added to the silica particle dispersion in the subsequent process, the metal hydroxide is precipitated on the surfaces of the silica particles in the liquid. Next, the solution of the metal hydroxide is added dropwise into the silica particle dispersion of which temperature and pH have been adjusted. Thereafter, the temperature and the pH of the liquid are kept at the first temperature and the first pH, respectively, for a specific time period (for example, at least 30 minutes and no greater than two hours), thereby forming metal hydroxide layers on the surfaces of the silica particles in the liquid. As a result, a dispersion of the silica particles (also referred to below as intermediate particles) a least a part of each of which is covered with the metal hydroxide layer is obtained. In a configuration in which the metal hydroxide substantially forming the metal hydroxide layer is aluminum hydroxide, preferably, the first temperature is at least 40° C. and no greater than 50° C. and the first pH is at least 5.0 and no greater than 6.5 in order to accelerate formation of the metal hydroxide layers. In a configuration in which the metal hydroxide substantially forming the metal hydroxide layer is magnesium hydroxide, preferably, the first temperature is adjusted to at least 75° C. and no greater than 85° C. and the first pH is adjusted to at least 8.0 and no greater than 9.5 in order to accelerate formation of the metal hydroxide layers.

The temperature and the pH of the resultant dispersion of the intermediate particles are then adjusted to a second temperature (for example, normal temperature) and a second pH (for example, pH of at least 2 and no greater than 6), respectively. The second temperature and the second pH are determined such that a reaction of the coating material is caused on the surfaces of the intermediate particles in the liquid when the liquid is heated in a subsequent process. Next, the coating material (for example, a monomer for synthesizing a nitrogen containing resin) is added to the dispersion of the intermediate particles of which temperature and pH have been adjusted. The liquid is then increased up to a third temperature (for example, at least 50° C. and no greater than 85° C.) at a specific rate (for example, at least 0.1° C./min. and no greater than 3° C./min.) while being stirred. Further, the temperature of the liquid is kept at the third temperature for a specific time period (for example, at least 30 minutes and no greater than four hours). In doing so, the coating material is attached to the surfaces of the intermediate particles and the attached coating material is hardened through a polymerization reaction. As a result, a dispersion of the external additive particles of the present embodiment is obtained. In a configuration in which the coating layer is made substantially from a melamine resin or a urea resin, it is preferable in order to accelerate formation of the coating layers that: the second temperature is at least 20° C. and no greater than 40° C.; the second pH is at least 3 and no greater than 4; and the third temperature is at least 60° C. and no greater than 100° C.

Subsequently, the resultant dispersion of the external additive particles is cooled for example to normal temperature. The dispersion of the external additive particles is filtered then. Filtering the dispersion results in separation (solid-liquid separation) of the external additive particles from the liquid. The external additive particles obtained are washed then. The washed external additive particles are then dried. Through the above, the external additive containing the multiple external additive particles according to the present embodiment is obtained. Note that the above production method of the external additive can be altered freely in accordance with intended composition, properties, or the like of the required external additive particles. For example, the silica particles may be dispersed in a solution of the metal hydroxide after preparation of the solution of the metal hydroxide. Alternatively, the process of heating the solvent to the third temperature may be carried out before the process of adding the coating material to the solvent. In a situation in which a material is caused to react in a liquid (specifically, the solution of the metal hydroxide, the coating material, or the like), the material may be caused to react in the liquid for a while after being added to the liquid react in the liquid while being added to the liquid through addition of the material to the liquid over time. Furthermore, the coating material may be added to the solvent as a single addition or may be divided up and added to the solvent as a plurality of additions. Any method is employable for forming the coating layers. For example, the coating layers may be formed according to an in-situ polymerization process, an in-liquid curing film coating process, or a coacervation process. Note that non-essential processes may alternatively be omitted. Preferably, a large number of the external additive particles are formed at the same time in order that the external additive can be manufactured efficiently. The external additive particles produced at the same time are thought to have substantially the same configuration.

### EXAMPLES

The following describes examples of the present invention. Table 1 indicates toners A-1-A-4, B1-B-3, C, D-1, and D-2 (each are an electrostatic latent image developing toner) according to examples and comparative examples.

TABLE 1

Silica particles

| Toner | Metal oxide | Coating layer |
|---|---|---|
| A-1 | Metal oxide A | Resin A |
| A-2 | Metal oxide A | Resin B |
| A-3 | Metal oxide B | Resin A |
| A-4 | Metal oxide A | Resin A + Resin C |
| B-1 | — | Resin A |
| B-2 | — | Organic silane |
| B-3 | — | Silicone oil |
| C | Metal oxide A | Organic silane |
| D-1 | — | Resin C |
| D-2 | — | Resin A + Resin C |

The following describes respective production methods of the toners A-1-A-4, B-1-B-3, C, D-1, and D-2, evaluation methods, and evaluation results in order. In evaluations in which errors may occur, an evaluation value was calculated by calculating the arithmetic mean of an appropriate number of measured values in order to ensure that any errors were sufficiently small. Further, the volume median diameters (D₅₀) are measured by the following method.

<Method for Measuring Volume Median Diameter (D₅₀)>

Using a transmission electron microscope (TEM, “H-7100FA” produced by Hitachi High-Technologies Corporation), 100 or more sample particles (for example, external additive) are captured at a magnification of ×1,000,000 to obtain a TEM photograph. Subsequently, each equivalent circular diameter of arbitrarily selected 100 sample particles (i.e., a diameter of a circle having the same surface area as projection of the particle) is measured through analysis of the captured TEM photograph using image analysis software (“WinROOF” produced by Mitani Corporation) and the volume median diameter (D₅₀) is calculated from the 100 measurement values (equivalent circular diameters).

[Production Method of Toner A-1]

(Preparation of Toner Mother Particles)

In a production method of the toner A-1, toner mother particles are prepared according to the following processes. First, an FM mixer (“FM-10” produced by Nippon Coke & Engineering Co., Ltd.) was used to mix 87 parts by mass of a polyester resin (“POLYESTER (registered Japanese trademark) HP-313” produced by The Nippon Synthetic Chemical Industry Co., Ltd.), 3 parts by mass of a carbon black (“MA-100” produced by Mitsubishi Chemical Corporation), 4 parts by mass of a carnauba wax (product of TOA KASEI CO., LTD.), 2 parts by mass of a charge control agent (nigrosine: “BONTRON (registered Japanese trademark) N-71” produced by ORIENT CHEMICAL INDUSTRIES, Co., Ltd.), and 4 parts by mass of a positively chargeable polymer charge control agent (“Acrybase (registered Japanese trademark) FCA-201-PS” produced by FUJIKURA KASEI CO., LTD., component: styrene-acrylic acid-based resin including a repeating unit derived from quaternary ammonium salt).

Subsequently, the resultant mixture was melt-knead using a twin screw extruder (“TEM-265S” produced by Toshiba Machine Co. Ltd.). The resultant kneaded substance was cooled then. The cooled kneaded substance was coarsely pulverized under a condition of a preset particle diameter of 2 mm using a pulverizer (“Rotoplex (registered Japanese trademark) Type 16/8” produced by Hosokawa Micron Corporation). Furthermore, the resultant coarsely pulverized substance was finely pulverized using a pulverizer (“Turbo Mill (RS type)” produced by FREUND-TURBO CORPORATION). The finely pulverized substance obtained was then classified using a classifier (“Elbow Jet Type EJ-LABO” produced by Nittetsu Mining Co., Ltd.). Through the above, toner mother particles having a volume median diameter (D₅₀) of 7.0 μm were prepared.

(Preparation of External Additive A-1)

A silica particle dispersion was prepared by mixing 500 mL of ion exchanged water and 50 g of silica particles for 30 minutes at normal temperature using a mixer (“T.K. Hivis Disper Mix Type HM-3D-” produced by PRIMIX Corporation) at a rotational speed of 30 rpm. A water soluble fumed silica (“AEROSIL (registered Japanese trademark) 200” produced by Nippon Aerosil Co., Ltd.) having a specific surface area of 200 m²/g was used as the silica particles.

Next, metal hydroxide layers were formed on the surfaces of the silica particles through the following processes. First, the silica particle dispersion obtained as above was heated up to 45° C. and 50 mL of an aqueous solution of sodium aluminate at a concentration of 50 g/L was added dropwise into the liquid at a temperature of 45° C. over one hour. An aqueous solution of 0.5N-sodium hydroxide was also added dropwise into the liquid in addition to the sodium aluminate solution to adjust the pH of the silica particle dispersion to 6. The processes from the liquid heating to the pH adjustment is referred collectively to below as a metal hydroxide layer formation step A-1.

After the metal hydroxide layer formation step A-1, the resultant silica particle dispersion was cooled to 30° C. Next, 0.5N-hydrochloric acid (“Wako 1st Grade (087-01076)” produced by Wako Pure Chemical Industries, Ltd.) was added to the silica particle dispersion to adjust the pH of the silica particle dispersion to 3.5.

Thereafter, 50 g of a water soluble methylol melamine (“Nikaresin (registered Japanese trademark) S-260” produced by NIPPON CARBIDE INDUSTRIES CO. INC.) was added to the silica particle dispersion and the silica particle dispersion was stirred at a rotational speed of 30 rpm for five minutes at normal temperature. The silica particle dispersion was then moved from the mixer to a 1-L separable flask equipped with a thermometer and a stirrer. The stirrer included a stirring impeller for stirring a flask content (“AS ONE Stirring Impeller Type R-1345” available at AS ONE Corporation) and a motor for rotating the stirring impeller (“AS ONE Tornado Motor 1-5472-04” available at AS ONE Corporation).

Subsequently, the flask contents were increased up to 70° C. at a rate of 1° C. per 3 minutes while being stirred using the starrier. The temperature of the flask contents before the temperature increase started was 35° C. Then, the flask contents were stirred for 30 minutes using conditions of a temperature of 70° C. and a rotational speed of 90 rpm. As a result, metal hydroxide layers and coating layers were formed on the surfaces of the silica particles in the flask. Thereafter, the flask contents were cooled to normal temperature, thereby obtaining a dispersion of an external additive.

The dispersion of the external additive obtained as above was filtered (solid-liquid separated) using a Buchner funnel to collect a wet cake of the external additive. The collected wet cake of the external additive was then dispersed in an ethanol aqueous solution at a concentration of 50% by mass. Through the above dispersion, a slurry of the external additive was obtained. Next, the external additive in the slurry was dried using a continuous type surface modifier (Coatmizer (registered Japanese trademark) produced by Freund Corporation) under conditions of a hot air flow temperature of 45° C. and a flow rate of 2 m³/minute. As a result, a coarse powder of the external additive was obtained.

The dried coarse powder of the external additive was then pulverized using a ultrasonic jet pulverizer (“Jet Mill Type IDS-2” produced by Nippon Pneumatic Mfg. Co., Ltd.) under a condition of pulverization pressure of 0.6 MPa. A ceramic flat plate was used as a collision plate in the pulverization. An external additive (fine particles) having a volume median diameter (D₅₀) of 20 nm was obtained by the pulverization.

The obtained external additive (fine particles) is referred to below as an external additive A-1. The external additive particles included in the external additive A-1 each had a metal hydroxide layer made substantially from an aluminum hydroxide (Metal hydroxide A) and a coating layer made substantially from a melamine resin (Resin A).

(External Addition)

The toner mother particles were subjected to external addition. Specifically, 100 parts by mass of the toner mother particles, 1.5 parts by mass of the external additive A-1, and 1.0 part by mass of titanium oxide particles (“MT-500B” produced by TAYCA CORPORATION, titanium oxide fine particles not subjected to treatment) were mixed together for five minutes using an FM mixer (“FM-10” produced by Nippon Coke & Engineering Co., Ltd.) at a rotational speed of 3,500 rpm to attach the external additive (external additive A-1 and titanium oxide particles) to the surfaces of the toner mother particles. Through the above, a toner A-1 including multiple toner particles was produced.

[Production Method of Toner A-2]

The toner A-2 was produced according to the same method as for the toner A-1 in all aspects other than that an external additive A-2 was used in place of the external additive A-1. The external additive A-2 was prepared according to the same method as for the external additive A-1 in all aspects other than that 50 g of an aqueous solution of methylol urea (“MIRBANE (registered Japanese trademark) RESIN SU-100” produced by Showa Denko K.K., solid concentration: 80% by mass) was used in place of 50 g of the water soluble methylol melamine. External additive particles included in the external additive A-2 each had a metal hydroxide layer made substantially from Al(OH)₃ (Metal hydroxide A) and a coating layer made substantially from a urea resin (Resin B). The external additive A-2 has a volume median diameter (D₅₀) of 20 nm.

[Production Method of Toner A-3]

The toner A-3 was produced according to the same method as for the toner A-1 in all aspects other than that an external additive A-3 was used in place of the external additive A-1. The external additive A-3 was prepared according to the same method as for the external additive A-1 in all aspects other than that a metal hydroxide layer formation step A-3 was carried out in place of the metal hydroxide layer formation step A-1.

Metal hydroxide layers were formed on the surfaces of the silica particles according to the following manner in the metal hydroxide layer formation step A-3. First, 500 mL of a slurry of magnesium hydroxide at a concentration of 40 g/L was added to the silica particle dispersion. Further, sulfuric acid was added dropwise to the liquid together with the slurry over one hour to adjust the pH of the silica particle dispersion to 9. Subsequently, the temperature of the silica particle dispersion was kept at 80° C. for one hour by heating the liquid. As a result, metal hydroxide layers were formed on the surfaces of the silica particles. External additive particles included in the external additive A-3 each had a metal hydroxide layer made substantially from a magnesium hydroxide (Metal hydroxide B) and a coating layer made substantially from a melamine resin (Resin A). The external additive A-3 had a volume median diameter (D₅₀) of 22 nm.

[Production Method of Toner A-4]

The toner A-4 was produced according to the same method as for the toner A-1 in all aspects other than that an external additive A-4 was used in place of the external additive A-1. The external additive A-4 was prepared according to the same method as for the external additive A-1 in all aspects other than that 25 g of a water soluble methylol melamine (“Nikaresin S-260” produced by NIPPON CARBIDE INDUSTRIES CO. INC.) and 25 g of an aqueous solution of urethane resin (“SUPERFLEX (registered Japanese trademark) 170” produced by DKS Co. Ltd., solid concentration: 30% by mass) were used in place of 50 g of the water soluble methylol melamine. External additive particles included in the external additive A-4 each had a metal hydroxide layer made substantially from Al(OH)₃ (Metal hydroxide A) and a coating layer made substantially from a melamine resin (Resin A) and a urethane resin (Resin C). The external additive A-4 had a volume median diameter (D₅₀) of 22 nm.

[Production Method of Toner B-1]

The toner B-1 was produced according to the same method as for the toner A-1 in all aspects other than that an external additive B-1 was used in place of the external additive A-1. The external additive B-1 was prepared according to the same method as for the external additive A-1 in all aspects other than that the metal hydroxide layer formation step A-1 was not carried out. External additive particles included in the external additive B-1 each had a coating layer made substantially from a melamine resin (Resin A). The external additive B-1 had a volume median diameter (D₅₀) of 21 nm.

[Production Method of Toner B-2]

The toner B-2 was produced according to the same method as for the toner A-1 in all aspects other than that an external additive B-2 was used in place of the external additive A-1. A method for preparing the external additive B-2 will be described below.

(Preparation of External Additive B-2)

A mixer (“T.K. Hivis Disper Mix Type HM-3D-5” produced by PRIMIX Corporation) was charged with 500 mL of a toluene (“toluene grade 1” produced by Wako Pure Chemical Industries, Ltd.) and 2 g of γ-aminopropyltriethoxysilane and the γ-aminopropyltriethoxysilane was dissolved in the toluene.

Subsequently, 50 g of a water soluble fumed silica (“AEROSIL 200” produced by Nippon Aerosil Co., Ltd.) was added to the contents (toluene solution) of the mixer and the contents of the mixer was stirred at a rotational speed of 30 rpm for 30 minutes at normal temperature. Thereafter, the contents of the mixer was moved to a 1-L separable flask equipped with a thermometer and a stirrer. The stirrer included a stirring impeller for stirring a flask content (“AS ONE Stirring Impeller Type R-1345” available at AS ONE Corporation) and a motor for rotating the stirring impeller (“AS ONE Tornado Motor 1-5472-04” available at AS ONE Corporation).

Next, the flask contents were increased up to 75° C. at a rate of 1° C. pre three minutes while being stirred using the stirrer. The flask contents were further stirred for 30 minutes using conditions of a temperature of 75° C. (also referred to below as a coating layer formation temperature) and a rotational speed of 90 rpm. As a result, coating layers are formed on the surfaces of the silica particles in the flask.

Toluene was removed from the flask contents using a rotary evaporator. Thus, a solid was obtained. Subsequently, the resultant solid was dried using a reduced pressure dryer at a temperature set at 50° C. until the solid no longer lost weight. Furthermore, heating treatment was carried out for three hours using an electric furnace under a flow of nitrogen at a temperature set at 200° C. to introduce an amino group to the coating layers on the surfaces of the silica particles. As a result, a coarse powder of an external additive was yielded.

The coarse powder of the external additive was pulverized using a ultrasonic jet pulverizer (“Jet Mill Type IDS-2” produced by Nippon Pneumatic Mfg. Co., Ltd.) under a condition of pulverization pressure of 0.6 MPa. A ceramic flat plate was used as a collision plate in the pulverization. An external additive B-2 (fine particles) having a volume median diameter (D₅₀) of 22 nm was obtained by the pulverization. External additive particles included in the external additive B-2 each had a coating layer made substantially from organic silane (γ-aminopropyltriethoxysilane).

[Production Method of Toner B-3]

The toner B-3 was produced according to the same method as for the toner A-1 in all aspects other than that an external additive B-3 was used in place of the external additive A-1. The external additive B-3 was prepared according to the same method as for the external additive B-2 in all aspects other than that: 500 mL of n-hexane (“n-hexane grade 1” produced by Wako Pure Chemical Industries, Ltd.) was used in place of 500 mL of toluene; 0.2 g of amino modified silicone oil (“KF857” produced by Shin-Etsu Chemical Co., Ltd.) was used in place of 2 g of γ-aminopropyltriethoxysilane; the coating layer formation temperature was changed from 75° C. to 70° C.; and the temperature set in the reduced pressure dryer was changed from 50° C. to 70° C. The external additive B-3 had a volume median diameter (D₅₀) of 22 nm.

[Production Method of Toner C]

The toner C was produced according to the same method as for the toner A in all aspects other than that an external additive C was used in place of the external additive A-1. The external additive C was prepared according to the same method as for the external additive A-1 in all aspects from the metal hydroxide layer formation step A-1 after preparation of the silica particle dispersion through to adjustment of the temperature and the pH of the silica particle dispersion to 30° C. and 3.5, respectively. The processes thereafter in the method for preparing the external additive C was as follows.

Addition of 25 g of γ-aminopropyltriethoxysilane to the silica particle dispersion of which temperature and pH had been adjusted to 30° C. and 3.5, respectively, was carried out and the silica particle dispersion was stirred at a rotational speed of 90 rpm for four hours at normal temperature. Thereafter, an aqueous solution of 2N-sodium hydroxide was added dropwise into the silica particle dispersion to adjust the pH of the silica particle dispersion to 6.5. The silica particle dispersion was additionally stirred at a rotational speed of 90 rpm for two hours at normal temperature.

Next, the flask contents were filtered (solid-liquid separated) to obtain a sold. Thereafter, the resultant solid was re-dispersed in ion exchanged water. Dispersion and filtration were further repeated to wash the solid. Subsequently, the resulting solid was dried using a reduced pressure dryer at a temperature set at 130° C. As a result, a coarse powder of an external additive was obtained.

Subsequently, the coarse powder of the external additive was pulverized using a ultrasonic jet pulverizer (“Jet Mill Type IDS-2” produced by Nippon Pneumatic Mfg. Co., Ltd.) under a condition of a pulverization pressure of 0.6 MPa. A ceramic flat plate was used as a collision plate in the pulverization. An external additive C (fine particles) having a volume median diameter (D₅₀) of 20 nm was obtained by the pulverization. External additive particles included in the external additive C each included a metal hydroxide layer made substantially from an aluminum hydroxide (Metal hydroxide A) and a coating layer made substantially from an organic silane (γ-aminopropyltriethoxysilane).

[Production Method of Toner D-1]

The toner D-1 was produced according to the same method as for the toner A-1 in all aspects other than that an external additive D-1 was used in place of the external additive A-1. The external additive D-1 was prepared according to the same method as for the external additive B-1 in all aspects other than that 50 g of an aqueous solution of urethane resin (“SUPERFLEX 170” produced by DKS Co. Ltd., solid concentration: 30% by mass) was used in place of 50 g of the water soluble methylol melamine. External additive particles included in the external additive D-1 each had a coating layer made substantially from a urethane resin (Resin C). The external additive D-1 had a volume median diameter (D₅₀) of 21 nm.

[Production Method of Toner D-2]

The toner D-2 was produced according to the same method as for the toner A-1 in all aspects other than that an external additive D-2 was used in place of the external additive A-1. The external additive D-2 was prepared according to the same method as for the external additive B-1 in all aspects other than that 25 g of a water soluble methylol melamine (“Nikaresin S-260” produced by NIPPON CARBIDE INDUSTRIES CO. INC.) and 50 g of an aqueous solution of urethane resin (“SUPERFLEX (registered Japanese trademark) 170” produced by DKS Co. Ltd., solid concentration: 30% by mass) were used in place of 50 g of the water soluble methylol melamine. External additive particles included in the external additive D-2 each had a coating layer made substantially from a melamine resin (Resin A) and a urethane resin (Resin C). The external additive D-2 had a volume median diameter (D₅₀) of 20 nm.

[Evaluation Method]

Samples (toners A-1-A-4, B-1-B-3, C, D-1, and D-2) were each evaluated according to the following evaluation methods.

A two-component developer was prepared by mixing 100 parts by mass of a developer carrier and 10 parts by mass of the sample (toner) for 30 minutes using a ball mill. Resistance to environment and durability of the sample (toner) was evaluated using the prepared two-component developer. The developer carrier was prepared according to the following method.

<Developer Carrier Preparation Method>

A solution was obtained by dissolving 2 kg of an epoxy resin (“jER (registered Japanese trademark) 1004” produced by Mitsubishi Chemical Corporation) in 20 L of acetone. Subsequently, 100 g of diethylene triamine and 150 g of phthalic anhydride were added to the resultant solution to obtain a mixed liquid. The resultant mixed liquid and 10 kg of Mn—Mg—Sr ferrite cores (“EF-80B2” produced by Powdertech Co., Ltd., number average primary particle diameter: 80 μm) were loaded into a fluidized bed coating apparatus (“SPIR-A-FLOW (registered Japanese trademark) SFC-5” produced by Freund Corporation). Next, the surfaces of the ferrite cores were coated with the epoxy resin using the coating apparatus while hot air at a temperature of 80° C. was blown into the coating apparatus. The resultant resin coated particles were heated at 180° C. for one hour using a dryer. As a result, a developer carrier was obtained.

(Resistance to Environment of Toner in Normal-Temperature and Normal-Humidity Environment)

For evaluation of resistance to environment of a toner in a normal-temperature and normal-humidity environment, 330 g of the two-component developer prepared as above was added to a 500-mL polypropylene vessel and was left to stand in a normal-temperature and normal-humidity (20° C. and 60% RH) environment for 24 hours.

The developer was then taken out from the vessel and the charge of the toner in the taken developer was measured. The charge was measured using a Q/m meter (“MODEL 210HS-1” produced by TREK, INC.).

In the evaluation of resistance to environment of the toner in the normal-temperature and normal-humidity environment, a toner having a charge of at least 15.0 μC/g and no greater than 40.0 μC/g was evaluated as good (Good) and a toner having a charge of less than 15.0 μC/g or greater than 40.0 μC/g was evaluated as poor (Poor).

(Resistance to Environment of Toner in High-Temperature and High-Humidity Environment)

For evaluation of resistance to environment of a toner in a high-temperature and high-humidity environment, 330 g of the two-component developer prepared as above was added to a 500-mL polypropylene vessel and was left to stand in a high-temperature and high-humidity (28° C. and 80% RH) environment for 24 hours. The developer was then taken out from the vessel and the charge of the toner in the taken developer was measured. The charge was measured using a Q/m meter (“MODEL 210HS-1” produced by TREK, INC.).

In the evaluation of resistance to environment of the toner in the high-temperature and high-humidity environment, a toner having a charge of at least 12.0 μC/g was evaluated as good (Good) and a toner having a charge of less than 12.0 μC/g was evaluated as poor (Poor).

(Durability of Toner)

A color printer (“FS-05250DN” produced by KYOCERA Document Solutions Inc.) was used as an evaluation apparatus. The two-component developer prepared as above was loaded into a developing device of the evaluation apparatus and a sample (toner for replenishment) was loaded into a toner container of the evaluation apparatus. Durability of the toner in the normal-temperature and normal-humidity environment or the high-temperature and high-humidity environment was evaluated using the aforementioned evaluation apparatus. Note that an image density was measured using a reflectance densitometer (“SpectroEye (registered Japanese trademark)” produced by X-Rite Inc.). Also, the charge was measured using a Q/m meter (“MODEL 210HS-1” produced by TREK, INC.).

In the evaluation of durability of the toner in the normal-temperature and normal-humidity environment, prescribed durability tests (specifically, 10,000-printing durability test and 100,000-printing durability test described later) were carried out using the aforementioned evaluation apparatus in the normal-temperature and normal-humidity (20° C. and 60% RH) environment. Thereafter, a sample image including a solid portion was printed on evaluation paper and the image density (ID) of the solid portion in the sample image and the charge of toner in the developer of the developing device were measured. In the 10,000-prining durability test, a specific evaluation pattern (image) at a printing rate of 5% was serially printed on 10,000 recording mediums (A4-sized printing paper). In the 100,000-printing durability test, a specific evaluation pattern (image) at a printing rate of 5% was serially printed on 100,000 recording mediums (A4-sized printing paper).

In the evaluation of resistance to environment of the toner in the normal-temperature and normal-humidity environment, a toner having a charge of at least 12.0 μC/g and no greater than 27.0 μC/g was evaluated as good (Good) and a toner having a charge of less than 12.0 μC/g or greater than 27.0 μC/g was evaluated as poor (Poor). Furthermore, an image density of at least 1.20 was evaluated as good (Good) and an image density of less than 1.20 was evaluated as poor (Poor).

In the evaluation of durability of the toner in the high-temperature and high-humidity environment, the prescribed durability tests (specifically, the 10,000-printing durability test and the 100,000-printing durability test described above) were carried out in the high-temperature and high-humidity (28° C. and 80% RH) environment. Thereafter, a sample image including a solid portion was printed on evaluation paper and the image density (ID) of the solid portion in the sample image and the charge of toner in the developer of the developing device were measured.

In the evaluation of resistance to environment of the toner in the high-temperature and high-humidity environment, a toner having a charge of at least 8.0 μC/g was evaluated as good (Good) and a toner having a charge of less than 8.0 μC/g was evaluated as poor (Poor). Furthermore, an image density of at least 1.10 was evaluated as good (Good) and an image density of less than 1.10 was evaluated as poor (Poor).

[Evaluation Results]

Evaluation results of the respective toners A-1-A-4, B-1-B-3, C, D-1, and D-2 were indicated below. Table 2 indicates the evaluation results of charges, and Table 3 indicates the evaluation results of image densities.

TABLE 2

| | | Charge (μC/g) | | | | | |
|---|---|---|---|---|---|---|---|
| | | After left to stand for 24 hours | | 10,000-printing test | | 100,000-printing test | |
| | | Normal | High | Normal | High | Normal | High |
| | | temperature | temperature | temperature | temperature | temperature | temperature |
| | | and normal | and high | and normal | and high | and normal | and high |
| | Toner | humidity | humidity | humidity | humidity | humidity | humidity |
| Example 1 | A-1 | 35.0 | 30.1 | 20.1 | 16.8 | 18.3 | 12.8 |
| Example 2 | A-2 | 35.3 | 30.3 | 22.3 | 16.7 | 19.1 | 11.7 |
| Example 3 | A-3 | 36.2 | 31.2 | 22.2 | 16.1 | 18.9 | 12.1 |
| Example 4 | A-4 | 35.5 | 30.7 | 22.0 | 16.4 | 18.5 | 12.0 |
| Comparative | B-1 | 28.2 | 20.2 | 18.2 | 12.2 | 15.7 | 7.2 |
| Example 1 | | | | | | | (Poor) |
| Comparative | B-2 | 31.5 | 19.1 | 19.1 | 10.1 | 15.1 | 6.5 |
| Example 2 | | | | | | | (Poor) |
| Comparative | B-3 | 21.5 | 10.1 | 13.1 | 6.4 | 11.2 | 4.0 |
| Example 3 | | | (Poor) | | (Poor) | (Poor) | (Poor) |
| Comparative | C | 36.5 | 21.1 | 21.1 | 12.1 | 17.8 | 7.0 |
| Example 4 | | | | | | | (Poor) |
| Comparative | D-1 | 16.1 | 10.2 | 8.6 | 4.0 | 3.5 | 2.0 |
| Example 5 | | | (Poor) | (Poor) | (Poor) | (Poor) | (Poor) |
| Comparative | D-2 | 22.1 | 15.0 | 14.2 | 7.0 | 10.1 | 4.2 |
| Example 6 | | | | | (Poor) | (Poor) | (Poor) |

TABLE 3

| | | Image density | | | |
|---|---|---|---|---|---|
| | | 10,000-printing test | | 100,000-printing test | |
| | | Normal tem- | High tem- | Normal tem- | High tem- |
| | | perature | perature | perature | perature |
| | | and normal | and high | and normal | and high |
| | Toner | humidity | humidity | humidity | humidity |
| Example 1 | A-1 | 1.45 | 1.33 | 1.35 | 1.26 |
| Example 2 | A-2 | 1.37 | 1.34 | 1.38 | 1.24 |
| Example 3 | A-3 | 1.38 | 1.32 | 1.35 | 1.27 |
| Example 4 | A-4 | 1.38 | 1.33 | 1.32 | 1.25 |
| Comparative | B-1 | 1.46 | 1.27 | 1.29 | 1.08 |
| Example 1 | | | | | (Poor) |
| Comparative | B-2 | 1.41 | 1.12 | 1.30 | 0.98 |
| Example 2 | | | | | (Poor) |
| Comparative | B-3 | 1.43 | 1.00 | 1.20 | 0.60 |
| Example 3 | | | (Poor) | | (Poor) |
| Comparative | C | 1.42 | 1.14 | 1.32 | 1.02 |
| Example 4 | | | | | (Poor) |
| Comparative | D-1 | 1.47 | 0.95 | 1.48 | 0.55 |
| Example 5 | | | (Poor) | | (Poor) |
| Comparative | D-2 | 1.41 | 1.08 | 1.43 | 0.65 |
| Example 6 | | | (Poor) | | (Poor) |

As indicated in Tables 2 and 3, the toners A-1-A-4 (toners of Examples 1-4) each had the aforementioned features (1) and (2). Specifically, the toners of Examples 1-4 each included toner particles each including a toner mother particle and a plurality of external additive particles attached to the surface of the toner mother particle. The toner particle included first external additive particles that were the external additive particles having a configuration described below and second external additive particles (titanium oxide particles). The first external additive particles each included a silica particle, a metal hydroxide layer (layer of aluminum oxide hydroxide or magnesium hydroxide), and a coating layer. The metal hydroxide layer was disposed on the surface of the silica particle. At least a part of the coating layer was disposed on the surface of the metal hydroxide layer. The coating layer was made substantially from a nitrogen containing resin (specifically, at least one of a thermosetting melamine resin, a thermosetting urea resin, and a thermoplastic urethane resin). Confirmation through image analysis on a SEM photograph showed that a coat ratio (area ratio of a region of a surface region of the silica particle that was covered with the coating layer) of the first external additive particle was at least 80% and no greater than 95% in each of the toners A-1-A-4.

As indicated in Tables 2 and 3, the toners of Examples 1-4 each were excellent in positive chargeability and charge stability. Furthermore, an image having high image density could be formed with any of the toners of Examples 1-4.

According to the valuation results, the toners B-1, D-1, and D-2 (toners of Comparative Examples 1, 5, and 6) were evaluated as poor in at least one of the durability tests in the high-temperature and high-humidity environment. No metal hydroxide layers were formed on the surfaces of the silica particles in the respective toners of Comparative Examples 1, 5, and 6. It is thought therefore that the coating layers degraded in the durability tests with a result that the surfaces of the silica particles were exposed.

According to the evaluation results, the toners B-2, B-3, and C (toners of Comparative Examples 2, 3, and 4) were evaluated as poor in at least one of the durability tests in the high-temperature and high-humidity environment. Furthermore, toner scattering due to opposite charging of the toner occurred in the developing device of the evaluation apparatus (image forming apparatus). The coating layers of the toners of Comparative Examples 2, 3, and 4 each contained no nitrogen containing resin. Durability of the coating layers was thought to be insufficient. Chargeability of the external additive was thought to degrade through the durability tests.

### INDUSTRIAL APPLICABILITY

The toner according to the present invention can be used for image formation for example using a copier, a printer, or a multifunction peripheral.

1. A toner comprising a plurality of toner particles each including a toner mother particle and a plurality of external additive particles attached to a surface of the toner mother particle, wherein
the external additive particles each include a silica particle, a metal hydroxide layer disposed on a surface of the silica particle, and a coating layer at least a part of which is disposed on a surface of the metal hydroxide layer, and
the coating layer is made substantially from a nitrogen containing resin.

2. The toner according to claim 1, wherein
the coating layer contains a thermosetting resin as the nitrogen containing resin.

3. The toner according to claim 2, wherein
the coating layer contains at least one of a melamine resin and a urea resin as the thermosetting resin.

4. The toner according to claim 2, wherein
the coating layer further contains a thermoplastic resin as the nitrogen containing resin.

5. The toner according to claim 1, wherein
an area ratio of a region of a surface region of the silica particle that is covered with the coating layer is at least 80% and no greater than 95%.

6. The toner according to claim 1, wherein
the coating layer has a first portion located on the surface of the silica particle and a second portion located on the surface of the metal hydroxide layer,
a bond derived from a silanol group is formed between the silica particle and the first portion of the coating layer, and
a bond derived from a methylol group is formed between the metal hydroxide layer and the second portion of the coating layer.

7. The toner according to claim 1, wherein
the metal hydroxide layer contains at least one of an aluminum hydroxide and a magnesium hydroxide.

8. The toner according to claim 1, wherein
the metal hydroxide layer is made substantially from an aluminum hydroxide.

9. The toner according to claim 1, wherein
the metal hydroxide layer is made substantially from a magnesium hydroxide.

10. The toner according to claim 1, wherein
in addition to the external additive particles, another type of external additive particles are attached to the surface of the toner mother particle.

11. The toner according to claim 1, wherein
the toner mother particle contains at least two positively chargeable charge control agents.

12. The toner according to claim 11, wherein
the toner mother particle contains a nigrosine and a resin including a repeating unit derived from a quaternary ammonium salt as the positively chargeable charge control agent.

13. The toner according to claim 11, wherein
the toner mother particle further contains a polyester resin.
